(19) United States
(12) Patent Application Publication
(10) Pub. No.: US 2025/0030464 A1
(43) Pub. Date: Jan. 23, 2025

(54) EFFICIENT SUCCESSIVE INTERFERENCE CANCELLATION DECODER FOR A MIMO COMMUNICATION SYSTEM

(71) Applicant: MMRFIC Technology Private Limited, Bangalore (IN)

(72) Inventors: Ganesan Thiagarajan, Bengaluru (IN); Sanjeev Gurugopinath, Bengaluru (IN)

(73) Assignee: MMRFIC Technology Private Limited, Bangalore (IN)

(21) Appl. No.: 18/731,391

(22) Filed: Jun. 3, 2024

(30) Foreign Application Priority Data
Jul. 13, 2023 (IN) 202341047370

(51) Int. Cl. H04B 7/0456; H04B 7/06

(52) U.S. Cl. CPC H04B 7/0456; H04B 7/0663

(57) ABSTRACT

According to an aspect, method of decoding a set of symbols from the plurality of signals received on multiple antennas of a receiver in a MIMO (Multiple input and Multiple Output) communication system, the method comprises receiving a first set of signals on a corresponding a first set of antennas, receiving a channel characteristics corresponding to the first set of signals, wherein the channel characteristics are arranged in a first matrix form, performing Hermitian transform on the channel characteristic to form a second matrix, wherein the second matrix is a covariant matrix, performing Cholesky decomposition on the second matrix to generate a third matrix, wherein the third matrix is a triangular matrix, performing successive interference cancellation using the third matrix and the first set of signal to generate an estimate of the set of symbols. According to another aspect, comprising the method further comprises partitioning the second matrix into sub matrices that are of the order less than the order of the second matrix and performing the Cholesky decomposition recursively on the partitioned sub matrices.

### BACKGROUND

### Cross References to Related Applications

This application claims priority from Indian Patent application No.: 202341047370 filed on Jul. 13, 2023 which is incorporated herein in its entirety by reference.

### Field of Invention

Embodiments of the present disclosure relate to electronic communication system and more particularly relate to an efficient successive interference cancellation decoder for a MIMO communication system.

### Related Art

A MIMO (Multiple Input and Multiple Output) communication system employs multiple antennas for transmission of information and/or multiple antennas for receiving the information. Information in the form of symbols is transmitted over the multiple antennas and correspondingly received on multiple antennas as is well known in the art. In certain MIMO communication systems, one (say a first) symbol is transmitted over multiple antennas at a given time and another (say a second) symbol is transmitted over multiple antennas at a second time instance so on and so forth. This is often referred to as spatial diversity. In certain other MIMO communication systems, multiple symbols (say a set of symbols) are transmitted over the corresponding multiple antennas at a given time instance and another set of symbols are transmitted over multiple antennas at a second time instance so on and so forth. This is often referred to as spatial multiplicity or spatial multiplexing. Decoding or detecting the symbols in the latter system (spatial multiplicity) is more challenging due to transmission of multiple symbols at the same time; as signal (symbol) transmitted from one antenna interfere with the other symbol transmitted from other antenna. In general, when multiple symbols are transmitted simultaneously over the same time slot and frequency resources, the receiver needs to remove the effect of the channel (noise, delay and fading etc.) as well as remove the effect of the inter-mixing of the symbols (interference) from different transmitter antennas.

Conventionally, several techniques are used for estimating/decoding/detecting/extracting the signal at the receiver. For example, in certain conventional techniques, the data is pre-coded at the transmitted with the knowledge of the channel state/statistics/behavior. This may reduce the data rate or needs additional information of the channel at the receiver. In certain other conventional techniques, a SIC (Successive interference cancellation (SIC), as is well known in the art) based decoders are employed. In such SIC decoder, the Channel characteristic (the matrix representing the channel) is first decomposed for performing the SIC. For example, if the channel characteristic is represented by matrix [H] and the set of symbols are represented by matrix [X] then the received signals may be represented as [Y]=[H][X]. Conventional decomposing of the matrix [H] using QR decomposition technique is well known in the art. However, such SIC decoders can result in colored noise at the receiver for different symbols resulting in increased symbol errors for a given signal-to-noise ratio (SNR). Further, QR decomposition based SIC decoding techniques are complex and computationally intensive. These QR based decoders are popular, but they operate on the full channel matrix making it more complex, numerically sensitive and computationally intensive. That apart, channel matrix decomposition based SIC decoders in general can generate colored noise thus enhancing the probability of error while detecting the symbols for the given signal to noise ratio.

In certain other conventional decoders, more exhaustive search operations are performed for all possible symbol combinations. These techniques are also referred as sphere decoding in the field of art. Apparently the technique is computationally intensive and provides a sub-optimal solution where the search range for the symbols is limited within a small radius of a sphere.

### SUMMARY

According to an aspect, method of decoding a set of symbols from the plurality of signals received on multiple antennas of a receiver in a MIMO (Multiple input and Multiple Output) communication system, the method comprises receiving a first set of signals on a corresponding a first set of antennas, receiving a channel characteristics corresponding to the first set of signals, wherein the channel characteristics are arranged in a first matrix form, performing Hermitian transform on the channel characteristic to form a second matrix, wherein the second matrix is a covariant matrix, performing Cholesky decomposition on the second matrix to generate a third matrix, wherein the third matrix is a triangular matrix, performing successive interference cancellation using the third matrix and the first set of signal to generate an estimate of the set of symbols.

According to another aspect, comprising the method further comprises partitioning the second matrix into sub matrices that are of the order less than the order of the second matrix and performing the Cholesky decomposition and their inverse recursively on the partitioned sub matrices which reduces the computations as well as memory requirements in embedded applications.

### BRIEF DESCRIPTION OF DRAWINGS

FIG. 1 is an example MIMO communication system in an embodiment.

FIG. 2 is a block diagram of an example receiver signal processor in one embodiment.

FIG. 3 is a block diagram illustrating the manner in which the receiver signal processor may be implemented in an embodiment.

FIG. 4A is a block diagram illustrating the manner in which the Cholesky decomposition may be performed in an embodiment.

FIG. 4B illustrates the recursive Cholesky decomposition.

### DETAILED DESCRIPTION OF THE PREFERRED EXAMPLES

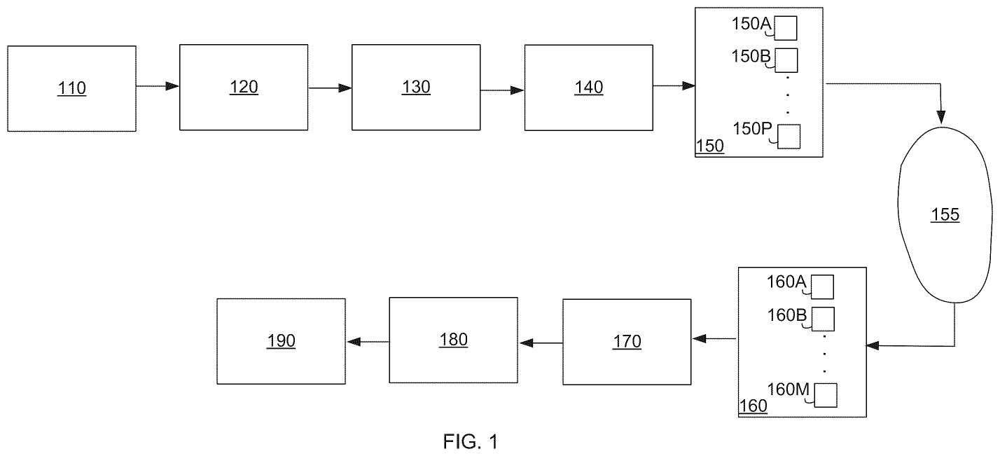

FIG. 1 is an example MIMO communication system in an embodiment. The environment 100 is shown comprising a signal source 110, symbols generator 120, transmit (side) signal processor 130, transmit (side) RF section 140, MIMO transmitter antenna 150, channel 155, MIMO receiver antenna 160, receive (side) RF section 170, receiver (side) signal processor 180, output device 190. Each element is further described below.

The signal source 110 provides the information for transmitting over the communication channel 155. The information source may be audio, video, radar signal, media signal, data etc. In certain embodiment the signal source 110 may comprise microphone, video camera, database, data repository etc. The information provided by the signal source 110 may be in analog form or digital form.

The symbols generator 120 receives the information and converts the information into sequence of symbols. The symbol generator may employ any known encoding techniques (also referred to as modulation techniques) such as Amplitude modulation (PAM, QAM, etc.,) Phase Shift Keying, Frequency Shift Keying (QPSK, MSK, etc.,) as is well known in the art. Each symbol may carry piece of information corresponding to one bit or two bits or four bits, etc. The symbols thus generated is provided to the transmit signal processor 130.

The transmit (side) signal processor 130 generates the signal for transmission over MIMO antenna array 150. The transmit signal processor 130 may perform one of spatial diversity or spatial multiplicity transmission pattern or combinations thereof. For example, transmit signal processor 130 may configure the transmit RF section 140 and MIMO antenna 150 to transmit a set of symbols over a corresponding set of antennas in MIMO antenna 150. That is, a set of symbols may be transmitted in a first time slot over plurality of antennas. Accordingly, the signals are routed to different antennas through the transmit RF section 140. The transmitted symbols in a given time slot may be represented as X=[x1, x2, . . . xn], wherein the x1, x2, . . . xn representing the set of symbols. The signal configured for transmission over the antennas is provided to RF section 140. The processor 130 may control the circuit elements in blocks 120, 140, and 150 to cause transmission of multiple symbols over the multiple MIMO antenna elements. The transmit RF section 140 performs signal condition operations such as power gain, frequency conversion, filter operation, impedance matching etc., as is well known in the art. The signals ready for transmission over antennas are provided to the antenna 150.

The MIMO transmitter antenna 150 comprises array of antennas (elements) 150A-150P, each capable of transmitting a signal/symbol. In one embodiment, the antenna elements 150A-150P transmit different symbols in one time slot. That is each antenna element 150A-150P transmit different symbol over channel 155 at same time or overlapping in time. The channel 155 may be wireless channel capable of propagating electromagnetic waves in RF frequency range. P may be greater than or equal number of symbols “N” in the set of symbols.

The MIMO receiver antenna 160 comprises array of antenna element 160A-160M capable of receiving signal from the channel 155. In one embodiment, the antenna elements 160A-160M are configured to effectively receive the signal transmitted from the antenna 150. For example, the frequency range, dimension, direction, and power sensitivity of the antenna 160 are adjusted or correspond to that of the antenna 150. The received raw RF signal is provided to the receive RF section 170.

The receive RF section 170 receives the RF signal from the antenna 160 (M number of signals from M antennas) and perform signal conditioning operations on each signal (in conjunction with unit 140) such as amplification, frequency down conversion, filter operation, impedance matching operations etc. In certain embodiment the receive RF section 170 may also perform analog to digital conversion to provide the M streams of received signals in digital form. In certain embodiment the number of receiver antenna M may be greater than or equal to “N”

The receiver signal processor 180 extracts the symbols from the M streams of received signals. The extracted symbols are provided to output devices 190. The output device may comprise storage device, media player, another transmitter, etc. The received signal streams may be represented as Y=[y1, y2, . . . y_{M}], wherein M may be greater than N wherein N is equal to the total transmitted symbols x1, x2, . . . x_{N} in a given time period. In one embodiment, the receiver signal processor 180 is implemented with reduced complexity providing estimate of transmitted symbols x1, x2, . . . x_{N} with less probability of error (more accurate with the transmitted symbols) for a given signal to noise ratio. The manner in which the receiver signal processor 180 may be implemented in an embodiment is further described below.

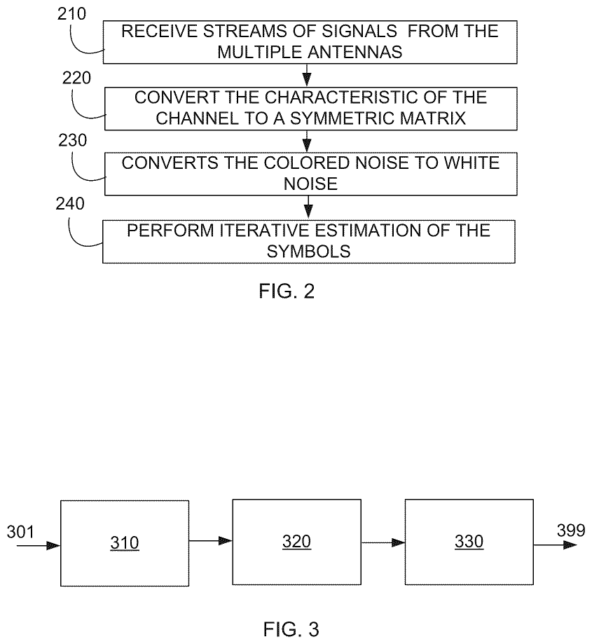

FIG. 2 is a block diagram of an example receiver signal processor in one embodiment. In the block 210, the receiver 180 receives streams of signals (signal streams) from the multiple antennas and also receives data representing the characteristic of the channel 155 (often referred to as channel transfer function). The characteristic of the channel may be stored in a memory prior to receiving the streams of signal or the characteristic of the channel may be received dynamically in real-time along with the streams of signals. The characteristic of the channel may be represented in the matrix form as [H] of order M×N, when the number of transmitted symbols is N and number of receiver antenna in the array 160 is M. Thus, M represents the number of streams/receiver antennas. The characteristic of the channel may be represented as:

$$H = ( \begin{matrix}{h}_{11} & … & {h}_{1 N} \\ ⋮ & ⋱ & ⋮ \\ {h}_{1 M} & … & {h}_{MN}\end{matrix} )$$

in that, the h₁₁ . . . h_{MN} (in general hᵢⱼ for all values of i from 1 to N and j from 1 to M) representing characteristic of the channel between ith transmit antenna to jth receive antenna elements.

The M streams of signals received may be represented as:

$$Y = ( \begin{matrix}{y}_{1} \\ ⋮ \\ {y}_{M}\end{matrix} )$$

wherein, y1 corresponds to signal received on antenna 1, y2 corresponds to signal received on antenna 2, so on so forth with y_{M} corresponds to signal received on Mth antenna. The [H] may corresponds to or take values corresponding to the time instant of receiving the [Y] streams. The received signal [Y] may be the transmitted signal [X] that is modified/affected by the channel [H] and a noise component. Thus, received signal [Y] may be represented as:

$$Y = ( \begin{matrix}{y}_{1} \\ ⋮ \\ {y}_{M}\end{matrix} ) = ( \begin{matrix}{h}_{11} & … & {h}_{1 N} \\ ⋮ & ⋱ & ⋮ \\ {h}_{1 M} & … & {h}_{MN}\end{matrix} ) ( \begin{matrix}{\tilde{x}}_{1} \\ ⋮ \\ {\tilde{x}}_{N}\end{matrix} ) + K , \qquad ( 1 )$$

wherein K is noise component and \tilde{X}=(\tilde{x}₁ . . . \tilde{x}_{N}) denotes the transmitted symbols X=[x1, . . . xN].

In the block 220, the receiver 180 converts (or determines the symmetry) of the general characteristic of the channel to a symmetric representation of characteristics. In one embodiment the receiver 180 may perform Hermitian transformation operation on the [H] to generate an N×N symmetric channel matrix where N is less than M. The Hermitian transformed matrix [H] may be represented as [H]^{H}. In one embodiment, the Hermitian transformation may be performed on the relation (1) above. Thus, the relation (1) may be represented as:

$$\tilde{Y} = {H}^{H} Y = {H}^{H} H \tilde{X} + {H}^{H} K . \qquad ( 2 )$$

In that, the operator H^{H} representing the Hermitian operation or covariance of the respective matrix and H^{H} H is a symmetric square matrix of order N×N. The H^{H} K term represents the instance of a coloured noise vector generated from the spatially white noise vector K.

In the block 230, the receiver 180, converts the coloured noise to white noise. In one embodiment, the receiver 180 performs Cholesky decomposition of the symmetric channel matrix H^{H} H to obtain the triangular matrix. For example, the Cholesky decomposition may be performed on H^{H} H obtained in the relation (2) and convert the coloured noise to white noise. The decomposition operation may be represented as:

$${L}^{- 1} \tilde{Y} = {Y}^{\approx } = {L}^{- 1} ( {H}^{H} H ) \tilde{X} + {L}^{- 1} ( {H}^{H} K ) . \qquad ( 3 )$$

In that, the operator L⁻¹ represents inverse of Cholesky matrix L. The relation (3) may be represented as:

$${Y}^{\approx } = {L}^{- 1} ( {LL}^{H} \tilde{X} + {L}^{- 1} {H}^{H} K ) = {L}^{H} \tilde{X} + {L}^{- 1} {H}^{H} K . {TheL}^{- 1} {H}^{H} K \qquad ( 4 )$$

term represents the instance ofspatially white noise vector obtained from the colored noise vector H^{H} K.

In the block 240, the receiver 180, perform iterative estimation of the symbols by first estimating the lowest dependency stream. As it may be appreciated that, the L^{H} (transpose of the Cholesky decomposition matrix) is an upper triangle matrix, and thus, symbols may be derived by performing SIC decoding technique. Accordingly, the receiver 180 performs iterative SIC decoding to determine estimate (\tilde{x}₁ . . . \tilde{x}ₙ) of the symbols X. Further since L⁻¹ H^{H} K is a white noise, the symbols so extracted are having lesser probability of error for a given signal to noise ratio (SNR). It may be appreciated that: the technology is described with mathematical relations for definitiveness and accuracy of the description so that a person of the relevant skill shall be able to exploit the details and implement the technology without ambiguity. The implementation of the same may be performed using any known hardware such as system on chip (SOC), computer processors executing the set of instructions etc. The manner in which the hardware implementation may be further simplified is described below.

FIG. 3 is a block diagram illustrating the manner in which the receiver signal processor may be implemented in an embodiment. The signal processor 300 is shown comprising Hermitian Transformers 310, Cholesky decomposer 320 and SIC decoder 330. Each element further described below.

The Hermitian Transformers 310 receives the stream of data from the M number of antennas on path 301. The stream of data may be represented as samples of the signal that is digitised to Q bits. The number of bits (Q) may be set to 32 bits, 64 bits, 128 bits etc., Thus, each element in the matrix Y represents the sample of the received signal on a corresponding antenna sampled at a given time instance. For example, the y1 representing the digital value of the sample received from antenna 1 at time instance t1, y2 representing the digital value of the sample received from antenna 2 at time instance t1, so on so forth. Similarly, the Hermitian transformer 310 also receives the channel characteristics arranged in two dimensional arrays (similar to Matrix H) for processing. The characteristic of the channels may be iteratively updated during the decoding process and may correspond to the estimated channel behaviour at the time of the sampling of the received signal Y. Each element in the array may be represented using number of bits such as 32, 64, 128 etc. In particular, the value of each element in the channel matrix represents the channel response between a transmitting antenna and a receiving antenna. In one embodiment, the Hermitian transformer 310 implemented to convert the matrix Y, H and K to its conjugate transpose form. In that, K is a predefined noise component in the received vector signal Y that may be updated dynamically based on the channel characteristic/model. The Hermitian transformed matrices are represented as H^{H}, Y^{H} and K^{H} and are provided for further processing to Cholesky decomposer. In one embodiment the Hermitian Transformers 310 may be implemented by way of VLSI circuit model in the form of an Intellectual Property (IP) core that may be integrated with the other processing circuit module.

Similarly, the Cholesky decomposer 320 performs Choleskey decomposition operation on the digital data H^{H}H, Y^{H} and K^{H} to produce Cholesky decomposed data L⁻¹H^{H}H, L⁻¹Y^{H}, and L⁻¹K^{H} respectively. In that, L⁻¹H^{H}H is an upper triangular matrix of the form:

$${L}^{- H} = ( \begin{matrix}{l}_{11} & {l}_{12} & {l}_{1 N} \\ 0 & {l}_{22} & {l}_{2 N} \\ 0 & 0 & {l}_{NN}\end{matrix} ) .$$

The L^{31 H} may be obtained by first performing the L (Cholesky decomposition) operation, its inverse computation and then by performing the transpose of the same.

The SIC decoder 330 estimates of the received symbol from the relation (4) by back substitution as: \tilde{x}=L^{-H} [symbol] wherein the L^{-H} is the inverse of the L^{H}. For example, the SIC decoder may first determine/estimate the \tilde{x}n using relation [symbol] ₙ =l_{NN}\tilde{x}ₙ+Noise. Similarly, next the \tilde{x}ₙ₋₁ may be determined using relation [symbol] ₙ₋₁=l_{N-1,N-1}\tilde{x}ₙ₋₁+l_{N-1,N}\tilde{x}ₙ₋₁+Noise. In a similar way other symbols may be estimated iteratively. The (first) symbol(s) estimated in one step of SIC may be stored in the memory and fetched for determining the next symbol in the next step of SIC. The estimated symbols are provided on path 399. The manner in which the Cholesky decomposer 320 may be implemented is further described below.

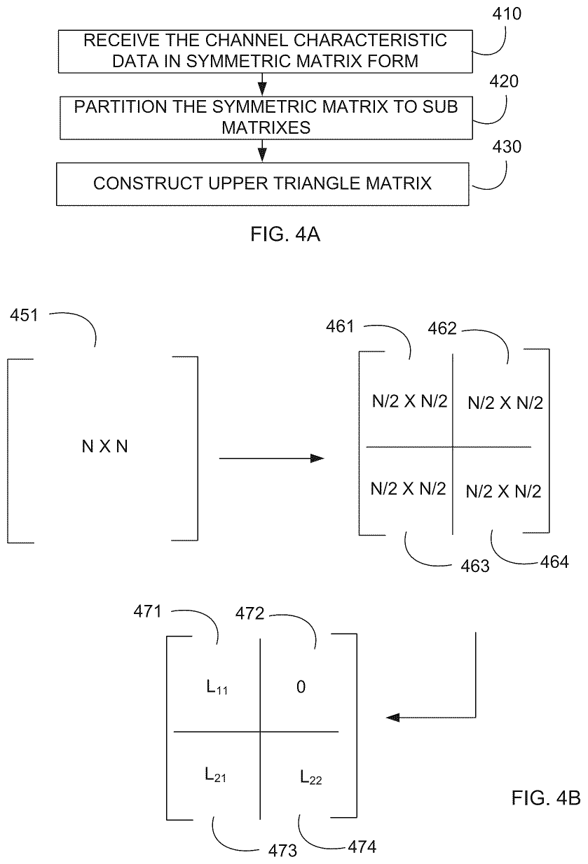

FIG. 4A is a block diagram illustrating the manner in which the Cholesky decomposition may be performed in an embodiment. In block 410, the channel characteristic data in the two-dimensional array form and that is symmetrical is received. For example the received Channel data may be in the form of a square matrix of order N×N. In one embodiment, the channel data received in the form of channel covariance matrix that comply to the requirement that every element h_{i,j}=h̅_{j,i} in the two dimensional array/matrix. In that, h̅_{j,i} representing the complex conjugate of h_{i,j} for every i and j.

In block 420, the Cholesky decomposer 320 creates/partitions sub array/sub matrices that are of the order less than the order of the array/matrix received in block 410. In other words, the Cholesky decomposer 320 may partition the received channel matrix/array into multiple sub matrices or arrays. For example, considering the received channel matrix is of the order N×N where N=2ⁿ, then the channel matrix may be portioned into four matrices of order N/2×N/2. In that, The Cholesky decomposer, perform the operation of Cholesky decomposition recursively on the partitioned matrices by considering one by one. FIG. 4B illustrates the recursive Cholesky decomposition. As shown there the 451 is the received symmetric channel matrix of order N×N. The 461-464 representing the portioned submatrices of order N/2×N/2. The 471-474 represents the Cholesky decomposed matrices corresponding to the 461-464. As may be appreciated, [461]=[471][471]^{T}, [462]=[472][472]^{T}, [463]=[462]^{T}=[473][473]^{T} and [464]=[473][473]^{T}+[474][474]^{T}. In that [] representing the matrix. Thus, Cholesky decomposition of any matrix may be derived from the decompositions of the sub-matrices or the partitioned matrices. It may be understood that above partitioning with equal dimensions N/2×N/2 is given here for illustration only and the technique is applicable for any division of N=N1+N2, N1 not equal to 0 and N2 not equal to zero.

In block 430, Cholesky decomposer 320 constructs the upper triangle matrix L^{-H} from the elements of the decomposed sub matrices. For example, the elements of the matrix 471, 473 and 474 are combined to first form the lower triangle matrix and then transpose operation is performed to obtain the upper triangle matrix. Accordingly, the computational complexity is further reduced. Hence the receiver 180 may operate at a relatively lower SNR conditions with reduced complexity (both in terms of hardware and/or processing power) and that does not produce colored noise.

While various embodiments of the present disclosure have been described above, it should be understood that they have been presented by way of example only, and not limitation. For example, a similar method of Hermitian matrix conversion, Cholesky decomposition and recursive symbol estimation using Successive Interference Cancellation (SIC) is relevant when the number of receive antennas M is smaller than the number of transmit antennas N, with suitable changes in (1)-(4) for the order in which H is multiplied with Y to obtain to Hermitian matrix format. Thus, the breadth and scope of the present disclosure should not be limited by any of the above-discussed embodiments but should be defined only in accordance with the following claims and their equivalents.

What is claimed is:

1. A method of decoding a set of symbols from the plurality of signals received on multiple antennas of a receiver in a MIMO (Multiple input and Multiple Output) communication system, the method comprising:
receiving a first set of signals on a corresponding a first set of antennas;
receiving a channel characteristic corresponding to the first set of signals, wherein the channel characteristics are arranged in a first matrix form;
performing Hermitian transform on the channel characteristic to form a second matrix, wherein the second matrix is a covariant matrix;
performing Cholesky decomposition on the second matrix to generate a third matrix, wherein the third matrix is a triangular matrix;
performing successive interference cancellation using the third matrix and the first set of signal to generate an estimate of the set of symbols.

2. The method of claim 1, wherein the first set of received signals is equal to:
$$Y = ( \begin{matrix}{y}_{1} \\ ⋮ \\ {y}_{M}\end{matrix} ) = ( \begin{matrix}{h}_{11} & … & {h}_{1 N} \\ ⋮ & ⋱ & ⋮ \\ {h}_{1 M} & … & {h}_{MN}\end{matrix} ) ( \begin{matrix}{\tilde{x}}_{1} \\ ⋮ \\ {\tilde{x}}_{N}\end{matrix} ) + K ,$$
in that, h₁₁ . . . h_{MN} representing the channel characteristics in the first matrix form, y₁ . . . Y_{M} representing the first set of signals, \tilde{x}₁ . . . \tilde{x}_{N} representing the estimate of the set of symbols and K representing the Noise.

3. The method of claim 2, wherein said performing Hermitian transform comprise the operation represented by the relation:
\tilde{Y}=H^{H}Y=H^{H}HH^{H}\tilde{X}+H^{H}K, in that the operation H^{H} representing the Hermitian operation on H, H representing the channel characteristic in the first matrix form, and \tilde{X} representing a matrix of the estimate of the set of symbols.

4. The method of claim 3, wherein said performing Cholesky decomposition comprise the operation represented by the relation:
L⁻¹\tilde{Y}= [symbol] =L⁻¹(H^{H}H)\tilde{X}+L⁻¹H^{H}K), In that, the operator L⁻¹ represents the said Cholesky decomposition operator.

5. The method of claim 4, further comprising partitioning the second matrix into sub matrices that are of the order less than the order of the second matrix and performing the Cholesky decomposition and its inverse recursively on the partitioned sub matrices.

6. The method of claim 5, further creating the spatially white noise vector and performing successive interference cancellation on the symbols to decode the data symbols.
